(19) United States
(12) Patent Application Publication
(10) Pub. No.: US 2004/0173651 A1
(43) Pub. Date: Sep. 9, 2004

(54) Configurable roof rack for automobiles

(76) Inventors: John Kim, Detroit, MI (US); Gordon Platto, Troy, MI (US); Bruce Williams, Grosse Pointe Park, MI (US)

Correspondence Address: MILLER LAW GROUP, PLLC, AND FORD GLOBAL TECHNOLOGIES, INC., 25 STEVENS AVENUE, WEST LAWN, PA, 19609, US

(21) Appl. No.: 10/801,430

(22) Filed: Mar. 16, 2004

Related U.S. Application Data
(63) Continuation-in-part of application No. 09/682,594, filed on Sep. 25, 2001.

(51) Int. Cl. B60R 9/00; B60R 9/042

(52) U.S. Cl. 224/310; 224/321

(57) ABSTRACT

A configurable roof rack apparatus includes storage surfaces movable between a first position that is generally coincident with a roof of a vehicle and a second position that is generally coincident with a side of a vehicle. The roof rack is formed with pivotally movable side rails that can be positioned in an upright position or in an inwardly collapsed position. The front and rear transverse rails are also pivotally positionable in a collapsed position to provide a substantially flat profile on the vehicle roof when the components are moved into the collapsed position and a basket-like structure when the components are moved into an upright position. Trim pieces are provided for interconnection between adjacent front and rear side rails to form the basket-like structure. A retractable trim piece is housed in one of the side rails and can be extended to engage the adjacent side rail.

### CROSS-REFERENCE TO RELATED APPLICATIONS

This application claims priority from United States Provisional Patent Application Serial No. 60/259,005 filed on Dec. 29, 2000. This application is a continuation-in-part of U.S. patent application Ser. No. 09/682,594, filed Sep. 25, 2001.

### BACKGROUND OF THE INVENTION

The present invention relates generally to an automotive roof rack system and more particularly to an automotive roof rack system with increased functionality.

Considerable effort has been exhausted by automotive engineers in an attempt to increase the utility of modern automotive designs. Although mere transportation of occupants still remains a primary objective, the modern automotive vehicle is often designed to provide a greater range of utilities. Design considerations such as customer convenience, ease of use, and increased functionality contribute significant impetus into the ever-evolving automotive designs. One particular area of design, requiring such considerations, and important to the increased utility of the vehicle, is the area of vehicle storage capacity.

Improvements to vehicle storage capacity have taken on a wide variety of forms. One set of improvements has led to an increase in storage capacity within the vehicle compartment. Although vehicles such as SUVs and minivans may provide such increased storage within the vehicle compartment, vehicle owners often prefer to utilize this space to increase passenger occupant capacity rather than for storage. Other, and possibly more traditional, storage techniques utilize separate compartments often positioned in the rear of the vehicle. These areas, commonly referred to as trunks, provide storage isolated from the passenger compartment. The size of these compartments as well as the presence of a deck lid, however, often prevents their use for storage and transporting oversized objects. There is, therefore, often a need to store and transport oversized objects or a large quantity of objects without interfering with passenger occupancy areas. This ability is commonly not afforded by trunk space.

One traditional approach to providing such storage has been through the use of a roof rack. The use of roof racks dates back considerably in the history of automotive design. Their use allows occupants to store and transport objects on the roof of the vehicle without interfering with passenger occupancy and without the limitations of common trunk designs. Although their position on the roof of the vehicle can provide occupants with considerably storage, their very position often proves detrimental to the accessibility necessary to load and unload the stowed items. The advent of larger vehicles such as SUVs, vans, and minivans has exacerbated the accessibility problems often associated with present roof rack designs. Even relatively tall individuals can have difficulty loading and unloading roof racks on such large vehicles. An improvement to the accessibility of roof rack systems would be highly beneficial and would serve to increase consumer convenience and satisfaction.

In addition to problems arising involving accessibility, present roof rack systems can suffer from additional limitations. Often, a roof rack structure designed to accommodate the storage of smaller items may prove incompatible with the storage of larger items such as kayaks, bikes, and other large objects. One standard approach to the storage of small items has been the formation of a basket within the roof rack system. Although these baskets have proven highly convenient, it is also known that they can interfere with the mounting of larger storage items to the roof rack system. One solution has been to provide basket systems that may be mounted and unmounted from the roof rack system. This commonly requires assembly and disassembly procedures that can reduce the convenience of the roof rack system. In addition, removal of portions of the roof rack system may require storage of rack parts and, therefore, may be impractical in some scenarios. A more flexible roof rack system that could accommodate both small and large storage objects without requiring disassembly of the roof rack system would be highly beneficial. It would, therefore, be highly desirable to have a roof rack system with improved accessibility and increased flexibility to accommodate both large and small storage objects.

### SUMMARY OF THE INVENTION

It is, therefore, an object of the present invention to provide an automotive roof rack system with improved accessibility and improved flexibility.

In accordance with the objects of the present invention, an automotive roof rack system is provided. The automotive roof rack system includes at least one storage surface having a first position, generally coincident to the roof of the vehicle, and a second position, generally coincident to the side of the vehicle. The at least one storage surface is movable between the first position and the second position to provide an automotive roof rack system with improved accessibility and increased flexibility. In accordance with the objects of the present invention, an automotive roof rack system is provided. The automotive roof rack system includes at least one storage surface having a first position, generally coincident to the roof of the vehicle, and a second position, generally coincident to the side of the vehicle. The at least one storage surface is movable between the first position and the second position to provide cargo space on top of the vehicle for oversized objects as well as simultaneously provide cargo space along the side of the vehicle.

It is another object of this invention to provide an automotive roof rack apparatus that is convertible into a collapsed configuration to provide a substantially flat roof surface to facilitate the carrying of large objects thereon.

It is a feature of this invention that the roof rack apparatus can be configured into multiple orientations for transporting objects.

It is an advantage of this invention that the roof rack apparatus can be positioned in a configuration that would permit the mounting of objects on the roof rack in a plurality of different orientations.

It is another advantage of this invention that the rear portions of the roof rack apparatus are positionable in at least three orientations.

It is still another object of this invention to provide a roof rack apparatus that is movable into a position that is generally vertically oriented along the side of the vehicle.

It is another feature of this invention that the rear portion of the roof rack apparatus is slidably movable from a first position on the roof of the vehicle to a second position that is along the side of the vehicle.

It is another feature of this invention that the roof rack apparatus can be used to mount objects on the exterior side of the vehicle.

It is still another feature of this invention that the roof rack apparatus is movable between an upright position in which a basket-like structure is formed on the roof of the vehicle to a collapsed position in which the roof rack apparatus presents a substantially flat profile on the roof of the vehicle.

It is yet another object of this invention that the side rails of the front and rear portions of the roof rack apparatus are pivotally movable between an upright orientation and an inwardly pivoted collapsed orientation.

It is still another object of this invention to provide positionable trim pieces for interconnecting front and rear roof rack side rails when in an upright position to provide a uninterrupted basket-like structure on the roof of the vehicle.

It is yet another feature of this invention that the trim pieces can be retractably mounted in one side rail member for selective extension into engagement with an adjacent side rail member.

It is still another advantage of this invention that large objects can be more easily mounted on the roof of the vehicle when the roof rack apparatus is configured in the fully collapsed orientation.

It is still another object of this invention to provide a roof rack apparatus that is configurable in a plurality of positions to provide a flexible cargo carrying capability for an automotive vehicle that is durable in construction, inexpensive of manufacture, carefree of maintenance, facile in assemblage, and simple and effective in use.

These and other objects, features and advantages are accomplished according to the instant invention by providing a configurable roof rack apparatus includes storage surfaces movable between a first position that is generally coincident with a roof of a vehicle and a second position that is generally coincident with a side of a vehicle. The roof rack is formed with pivotally movable side rails that can be positioned in an upright position or in an inwardly collapsed position. The front and rear transverse rails are also pivotally positionable in a collapsed position to provide a substantially flat profile on the vehicle roof when the components are moved into the collapsed position and a basket-like structure when the components are moved into an upright position. Trim pieces are provided for interconnection between adjacent front and rear side rails to form the basket-like structure. A retractable trim piece is housed in one of the side rails and can be extended to engage the adjacent side rail.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a schematic right front perspective view of an automotive roof rack apparatus incorporating the principles of the instant invention, the roof rack apparatus being depicted in an upright first configuration;

FIG. 2 is a schematic right rear perspective view of the roof rack apparatus of FIG. 1 showing the right front portion in a collapsed orientation and the right rear portion being deployed in a lowered side operative orientation;

FIG. 3 is a schematic right rear perspective view of the roof rack apparatus of FIG. 1 depicting both the left and right front portions in a collapsed orientation and both the left and right rear portions being deployed in the lowered side operative orientation;

FIG. 4 is a schematic right front perspective view of the roof rack apparatus depicted in FIG. 1 but showing all of the portions being placed into an inwardly collapsed orientation, the front and rear transverse rails are lowered to form a substantially flat roof rack structure for the mounting of oversized objects thereto;

FIG. 5 is a schematic elevational view of a portion of the roof rack apparatus depicting a first embodiment of a trim piece spanning the gap between the front and rear collapsible rails;

FIG. 6 is a schematic elevational view of a second embodiment of a trim piece spanning the gap between the front and rear collapsible rails, the trim pieces being crafted to lend support to and assist in forming a basket structure above the roof structure; and

FIG. 7 is a schematic elevational view of the invention similar to that of FIG. 6, but with the trim piece retracted to facilitate the lowering of either or both of the front and rear portions.

### DETAILED DESCRIPTION OF THE PREFERRED EMBODIMENMTS

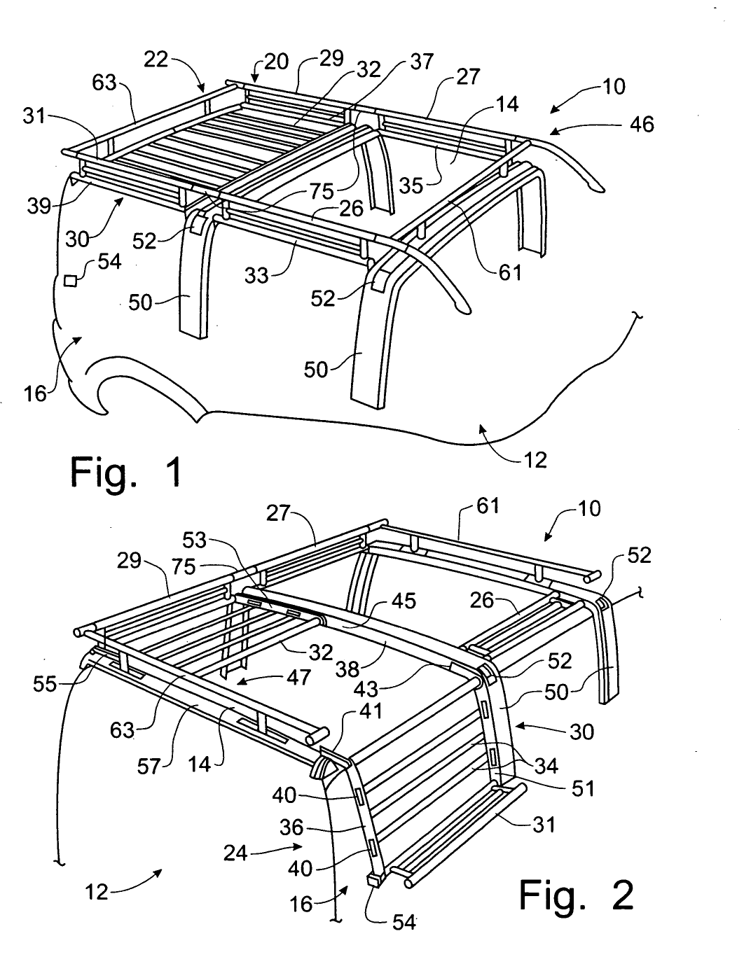

Referring now to FIGS. 1-4, a roof rack apparatus incorporating the principles of the instant invention can best be seen. Any references to left and right, and to front and rear, are used as a matter of convenience and are determined by standing at the rear of the automotive vehicle 12 and facing forwardly into the normal direction of travel of the vehicle 12. The roof rack system 10 is intended for use on an automobile 12 having a generally horizontally disposed roof portion 14 and a generally vertically disposed side portion 16. The conventional roof rack apparatus is known in the art for providing a structure for the mounting of objects to the roof of the automotive vehicle 12 for transport thereof over the highway. Typically, roof rack structures have slidably movable components that can be positionally adjusted along the surface of the roof portion 14 to provide the desired support of the object being mounted and a structure for a tie-down of the object to the roof rack apparatus with bungee cords, rope or the like.

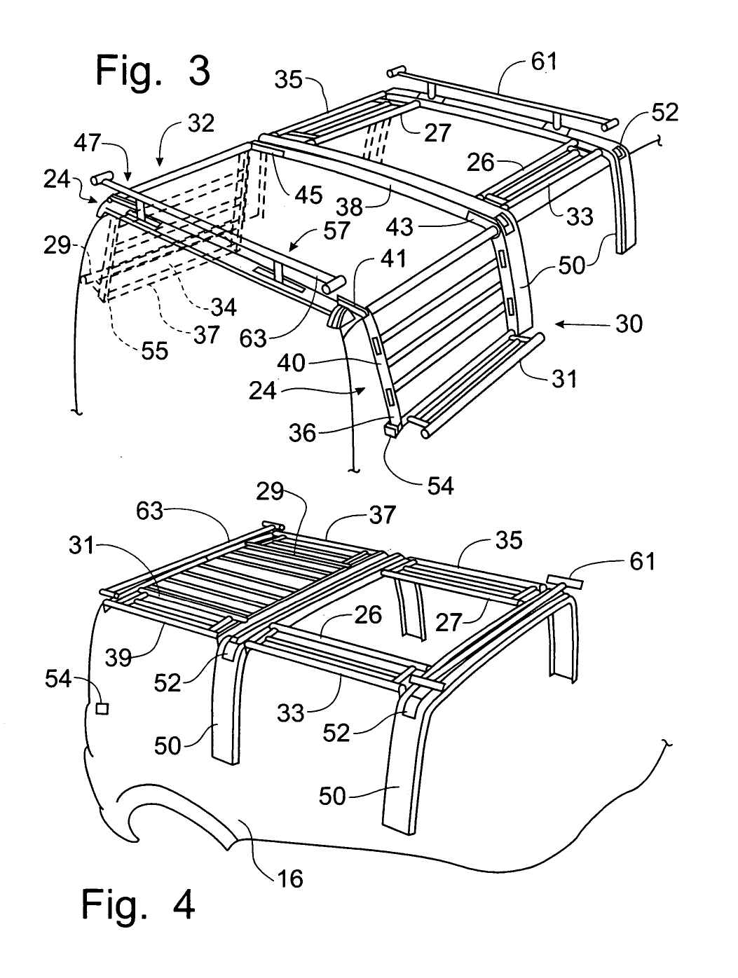

The roof rack system 10 includes left and right, and front and rear portions that define respective storage surfaces 20. Each of the left and right rear portions are movable between a first position 22 (best seen in FIG. 1), where storage surface 20 is generally coincident to the roof portion 14 of the automobile 12, and a second position 24 (best seen in FIGS. 2 and 3), where the corresponding storage surface 20 is generally parallel to the side portion 16 of the automobile 12. The capability of selectively moving the storage surfaces 20 from the first position 22 to the second position 24 provides a variety of benefits.

One set of benefits realized by the present invention involves accessibility of the roof rack system 10. In the prior art, when a storage surface was positioned on the roof portion 14 of the automobile 12, it was often difficult for many users to access the storage area due to the height of the vehicle 12. Often users were required to balance themselves within door frames or on tailgates in an effort to reach the roof portion 14. Even then, often portions of the storage surface 20 would be out of the reach of some users. The present invention improves upon on the accessibility of these designs by having a storage surface 20 that is movable between the first position 22 and the second position 24. Objects may be attached and detached from the storage surface 20 while the storage surface 20 is in the second position 24, allowing convenient and easy access to the storage surface 20 from the side of the vehicle. The storage surface 20 may then be moved back into the first position 22 for transport.

In another scenario, the storage surface 20 may be left in the second position 24 during transport. This configuration provides a convenient mounting surface for oversized objects to be secured onto the side of the vehicle during transport. While such mounting of objects will increase the overall operating width of the automotive vehicle 12, accessibility is improved since heavy and oversized objects need not be lifted to the height of the roof portion 14 of the vehicle 12 but only to the height of the side portion 16.

In addition to the improvements in accessibility, the present invention provides flexibility of use not often found in present roof rack designs. As has been discussed, the present invention can provide more storage on the side portion of the vehicle 16 as well as the roof portion 14. Additionally, by moving the storage surface 20 from the first position 22 to the second position 24, the roof rack system 10 may be more suitable for the mounting of oversized objects, such as skis, boats, or bikes, on the roof portion 14 of the automobile 12.

In one embodiment, the roof rack system 10 may further include a plurality of pivotally collapsible rails 26, 27, 29, 31. The plurality of collapsible rails 26, 27, 29, 31 when all of the collapsible rails 26, 27, 29, 31 are in the raised position (as shown by rails 27, 29 and 31 in FIGS. 1 and 2) provide a basket-like structure for objects mounted on the storage surfaces 20, 30, 32 (see FIG. 1). Each of the collapsible rails 26, 27, 29, 31 include a lower hinge bar 33, 35, 37, 39, respectively, that pivotally supports the side rails 26, 27, 29, 31 for movement between the upright position (represented by side rail 27 in FIGS. 1 and 2) and an inwardly collapsed position (represented by side rail 26 in FIG. 2). These side rails 26, 27, 29, 31 when all are positioned in the inwardly collapsed position convert the roof rack structure 10 into a substantially flat configuration that presents a low profile for the mounting of oversized objects on the top of the roof rack apparatus 10 in as low of a position as possible.

By way of example and with reference to FIG. 2, collapsible rail 26 rotates about hinge bar member 33 to free space and remove the roof rack obstruction above the vehicle 12 thereby allowing room for mounting over-sized objects close to the roof 14 of the vehicle 12. Accordingly, when all of the plurality of collapsible rails 26, 27, 29, 31 are moved into a collapsed position such as rail 26 illustrated in FIG. 2, the roof portion 14 of the automobile 12 is cleared of any obstructions that may interfere with the mounting of oversized objects to the roof 14 of the vehicle 12. Furthermore, the rear portions of the roof rack apparatus 10 can be moved into the second position 24 (see FIG. 3) to provide additional storage on the side portion 16 of the vehicle 12 while the roof portion 14 remains cleared for oversized objects. As is depicted in FIG. 4, the storage surfaces 20 may be left in the first position 22 and the plurality of collapsible rails 26 may be folded down to provide a roof portion 14 cleared of obstructions, as well as the side 16 of the vehicle 12.

Although the left storage surface 32 and the right storage surface 30 may be formed in a variety of fashions, in one embodiment, they include a plurality of slat elements 34 extending between track elements 36, 51, 53, 55. The track elements 36, 51, 53, 55 are pivotally affixed to their respective connecting members 41, 43, 45, 47. Connecting members 41, 43, 45, 47 slide along their corresponding rails 38, 57, as representatively shown in FIG. 2, to allow the storage surfaces 20, 30, 32 to move laterally from the first position 22 on top of the roof. The pivotal relationship between the track members 36, 51, 53, 55 and the corresponding connecting members 41, 43, 45, 47 permit the storage surfaces 20, 30, 32 to be positioned generally vertically into the second position 24 along the side 16 of the vehicle 12. The track elements 36, 51, 53, 55 may also include securing slots 40 to provide fastening points for attachment of fastening members, such as bungee cords and the like, for securing objects to the storage surface 20.

The collapsible rails 26, 27, 29, 31 serve a dual purpose. When the storage surface 20, 30, 32 are in the first position 22 on top of the roof 14 and the collapsible rails 26, 27, 29, 31 are in the raised position, a basket 46 is formed on the roof portion 14 of the vehicle 12. The basket 46, defined by the raised side rails 26, 27, 29, 31 and the raised front and rear transverse rails 61, 63, helps retain objects stored on the roof portion 14 of the vehicle 12 during transportation. Additionally, when one of the storage surfaces 20, 30, 32 are in the second position 24 and deployed out and along the side of the vehicle 12 as shown by storage surface 30 in FIG. 2, the corresponding collapsible rail (31 in FIG. 2) can serve as a base support for objects mounted on the side portion 16 of the vehicle. In other embodiments, however, the collapsible rails 26, 27, 29, 31 may be collapsed such that they are in a horizontal position and parallel to the vehicle roof to remove obstructions along the width of the vehicle thereby facilitating the transportation of very long or very wide objects.

The roof rack system 10 may further include a plurality of mounting elements 50. Although a variety of configurations are contemplated, in one embodiment the use of three mounting elements 50 is contemplated. It is contemplated that the mounting elements 50 may include latching areas 52 defined by recesses formed within the mounting elements 50. The latching areas 52 may be utilized as a convenient location to attach bungee cords or other securing straps commonly utilized to hold objects on the roof rack system 10. The present invention may further include a locking mechanism 54 for securing the storage surface 20 in the second position 24.

One skilled in the art will note that, with the lowering of the collapsible side rails 26, 27, 29, 31 into the inwardly collapsed positions, the desired profile for the roof rack apparatus 10 would be to form a substantially flat surface by positioning the side rails 26, 27, 29, 31 at a level beneath the top surface of the mounting elements 50. Clearly, the front side rails 26, 27 must be separable from the rear side rails 29, 31 in order to permit the independent movement of the front and rear portions of the roof rack apparatus 10, as is described in detail above. The formation of the basket 46 when the side rails 26, 27, 29, 31 are in the raised position would preferably include a continuous rail member that extends circumferentially around the basket 46 without a gap or break therein. To accomplish that basket structure 46, while providing the capability of lowering the side rails 26, 27, 29, 31 into an inwardly collapsed orientation, the side rails 26, 27, 29, 31 must be capable of forming a gap to accommodate the central mounting element 50 between the front and rear portions of the roof rack apparatus 10.

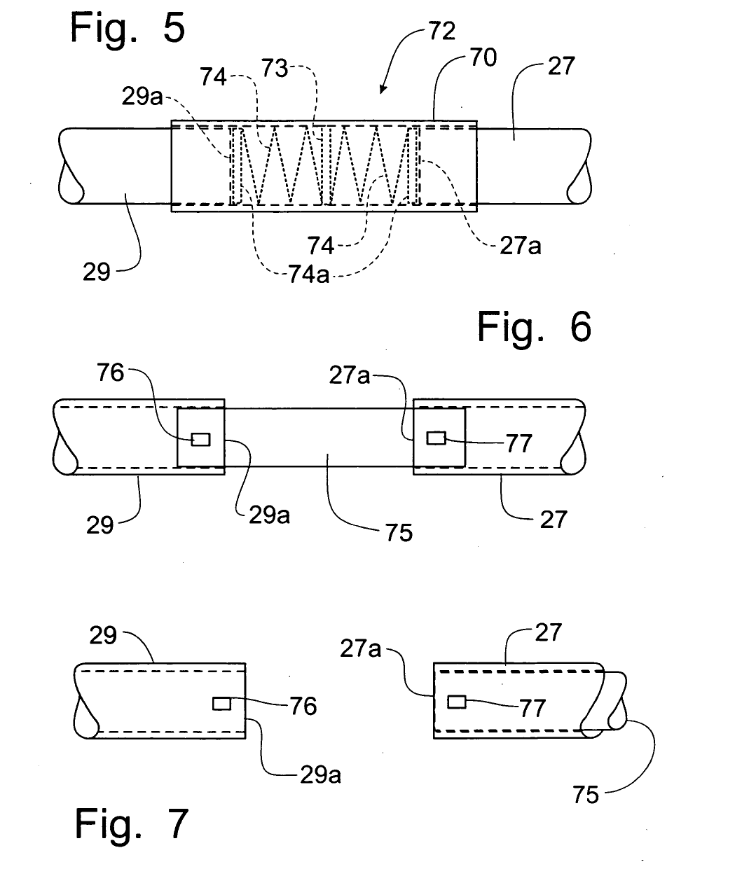

To form such a gap, the roof rack apparatus incorporates trim members 70 or 75 that are depicted in greater detail in FIGS. 5-7. One embodiment of a trim piece 70 is generally depicted in FIG. 5 as a removable trim member 70 that extends between the front and rear side rails 29, 27. The trim piece 70 can be formed with an internal spring mechanism 72 that substantially centers the trim piece 70 between the side rails 29, 27, or can be a snap-on trim member 70 that simply engages the adjacent ends of the front and rear side rail members 29, 27. The internal spring mechanism 72 can be formed in a variety of different forms, but could include a central anchor 73 from which opposing springs 74 extend. A plate 74a is attached to the end of each opposing spring 74 for engagement with the corresponding ends 27a, 29a for the side rail members 27, 29 so that the ends 27a, 29a of the side rail members 27, 29 will compress the springs 74 to center the trim piece 70 between the side rail members 27, 29 and effect a firm engagement therebetween.

An alternative embodiment of the trim member 75 is depicted in FIGS. 6-7. The trim member 75 can be housed in one of the side rail members 27 and be extendable therefrom for engagement with the opposing side rail member 29. Spring detents 76, 77 can be utilized to engage appropriate openings at the ends 27a, 29a in the opposing side rails 27, 29 to lock the trim piece in the selected position, either retracted in the one side rail member 27 as is depicted in FIG. 7, or interengaged between the adjacent front and rear side rail members 27, 29, as is depicted in FIG. 6. An optional cap member (not shown) can be snapped into engagement to cover the end 29a of the opposing side rail member 29 when the trim piece 75 is retracted into the other side rail member 27 by locking corresponding spring tabs into the openings 76. One advantage of the trim piece embodiment depicted in FIGS. 6-7 over the embodiment depicted in FIG. 5 is that the trim piece 75 is housed within the side rail 27 and does not constitute a loose part when disengaged from the opposing rail member 29.

The front and rear transverse rails 61, 63 are also preferably collapsible into a lowered position from a raised position in which the front and rear transverse rails 61, 63 help form the basket 46. While the supports for the front and rear transverse rails could be telescopic to permit the raised and lowered positional movement, the supports are preferably pivotally supported in the corresponding mounting element 50 to permit a lateral and lowered movement of the corresponding front and rear transverse rail members 61, 63, as is depicted in FIG. 4.

Alternatively, the front and rear transverse rails could be independent modular components that are simply detached from the roof rack system 10 and stored inside the vehicle 12. The mounting element 50 is preferably formed with recesses to receive the pivoted support member and facilitate the lowering of the transverse rail member 61, 63. Accordingly, when the side rails 26, 27, 29, 31 and the front and rear transverse rails 61, 63 are lowered into their respective collapsed positions, the roof rack structure 10 presents a substantially flat profile for the mounting of either very long or very wide objects on the roof rack apparatus 10.

The front transverse rail 61 can also be provided with optional additional trim pieces 79 connected to opposing sides of the front transverse rail 61 to provide a desired appearance. The additional trim pieces 79 add nothing structurally to the roof rack apparatus 10, but can be curved in shape to slope downwardly to the roof portion 14 of the vehicle 12. These additional trim pieces 79 would only be used when the front transverse rail 61 is positioned in the raised position, such as is depicted in FIG. 1. When the front transverse rail 61 is lowered into the collapsed position, the additional trim pieces 79 would be removed and stored for future use when the front transverse rail 61 is returned to the raised, basket-forming position.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A roof rack apparatus for an automotive vehicle having a generally horizontal roof portion and a generally vertical side portion, comprising:
at least one storage surface supported on said roof portion of said vehicle, said at least one storage surface including a side rail member positionable generally perpendicular to said at least one storage surface, said side rail member including a hinge bar pivotally supported on said at least one storage surface to permit pivotal movement of said side rail members relative to said at least one storage surface between a raised basket-forming position and a lowered collapsed position.

2. The roof rack apparatus of claim 1, wherein said roof rack includes a pair of laterally disposed front side rail members and a pair of laterally disposed rear side rail members, each said side rail member being pivotally movable independently of each other side rail member.

3. The roof rack apparatus of claim 2, wherein said roof rack apparatus further includes front and rear transverse rail members that form a basket with said side rail members when in said raised basket-forming position.

4. The roof rack apparatus of claim 3 wherein said front and rear transverse rail members are pivotally movable between said raised basket-forming position and a lowered collapsed position.

5. The roof rack apparatus of claim 4 wherein said at least one storage surface comprises a pair of laterally disposed storage surfaces corresponding to said rear side rail members, each said storage surface being movable laterally relative to the other said storage surface.

6. The roof rack apparatus of claim 5 wherein each said storage surface further includes:
a pair of longitudinally spaced track members, the corresponding said hinge bar for said rear side rail being pivotally supported by said track members to permit the pivotal movement of the corresponding said rear side rail member;
a plurality of longitudinally extending support members interconnecting said track members; and
a pair of connecting members slidably received in guide rails mounted to said vehicle roof portion, each said connecting member pivotally connecting one of said track members to permit pivotal movement of said track members relative to said guide rails such that said track members are laterally movable along said guide rails and pivotally movable relative to said guide rails to position said storage surface generally vertically along said side portion of said automotive vehicle.

7. The roof rack apparatus of claim 6 wherein said side rail members include a trim member selectively interengageable between adjacent front and rear side rail members, said trim member being movable to permit a gap to be formed between said adjacent front and rear side rail members when one of said side rail members is to be moved into said lowered collapsed position so that said side rail members can be lowered below said guide rails.

8. The roof rack apparatus of claim 7 wherein said trim member is housed within one of said adjacent front and rear side rail members and is extendible therefrom to engage the other of said adjacent front and rear side rail members when said adjacent front and rear side rail members are in said raised position, said trim member being retractable into said one of said adjacent front and rear side rail members when any of said adjacent front and rear side rail members are to be placed into said lowered collapsed position.

9. The roof rack apparatus of claim 7 wherein said trim piece is removable from said adjacent front and rear side rail members, said trim piece including an internal spring mechanism for maintaining engagement with said adjacent front and rear side rail members.

10. A roof rack apparatus for an automotive vehicle having a generally horizontal roof portion and a generally vertical side portion, comprising:
a pair of laterally disposed front side rail members;
a pair of laterally disposed rear side rail members in register with said front side rail members; and
a pair of laterally opposing storage surfaces supported on said roof portion, each of said rear side rail members being supported from one of said storage surfaces, said storage surfaces being movable laterally relative to the other said storage surface.

11. The roof rack apparatus of claim 10 wherein each said storage surface comprises:
a pair of longitudinally spaced track members,;
a plurality of longitudinally extending support members interconnecting said track members; and
a pair of connecting members slidably received in guide rails mounted to said vehicle roof portion, each said connecting member pivotally connecting one of said track members to permit pivotal movement of said track members relative to said guide rails such that said track members are laterally movable along said guide rails and pivotally movable relative to said-guide rails to position said storage surface generally vertically along said side portion of said automotive vehicle.

12. The roof rack apparatus of claim 11 wherein each of said side rail members includes a pivotally supported hinge bar to permit pivotal movement of said side rail member between a raised basket-forming position and a lowered collapsed position, said hinge bar for said rear side rail members being pivotally supported by said track members to permit the pivotal movement of the corresponding said rear side rail member.

13. The roof rack apparatus of claim 12 wherein said roof rack apparatus further comprises front and rear transverse rail members pivotally movable between said raised basket-forming position and a lowered collapsed position to form a basket with said side rail members when in said raised basket-forming position.

14. The roof rack apparatus of claim 13 wherein said side rail members include a trim member selectively interengageable between adjacent front and rear side rail members, said trim member being movable to permit a gap to be formed between said adjacent front and rear side rail members when one of said side rail members is to be moved into said lowered collapsed position so that said side rail members can be lowered below said guide rails.

15. The roof rack apparatus of claim 14 wherein said trim member is housed within one of said adjacent front and rear side rail members and is extendible therefrom to engage the other of said adjacent front and rear side rail members when said adjacent front and rear side rail members are in said raised position, said trim member being retractable into said one of said adjacent front and rear side rail members when any of said adjacent front and rear side rail members are to be placed into said lowered collapsed position.

16. The roof rack apparatus of claim 14 wherein said trim piece is removable from said adjacent front and rear side rail members, said trim piece including an internal spring mechanism for maintaining engagement with said adjacent front and rear side rail members.

17. A roof rack apparatus for an automotive vehicle having a generally horizontal roof portion and a generally vertical side portion, comprising:
a pair of laterally disposed front side rail members, each said front side rail members including a hinge bar being pivotally supported for movement of said front side rail member between a raised basket-forming position and a lowered collapsed position;
a pair of laterally disposed rear side rail members in register with said front side rail members; and
a pair of laterally opposing storage surfaces supported on said roof portion, each of said rear side rail members including a hinge bar pivotally supported from a corresponding one of said storage surfaces for movement between said raised basket-forming position and said lowered collapsed position, each said storage surface being mounted for independent movement laterally relative to the other said storage surface.

18. The roof rack apparatus of claim 17 wherein each said storage surface further includes:
a pair of longitudinally spaced track members, the corresponding said hinge bar for said corresponding rear side rail member being pivotally supported by said track members to permit the pivotal movement of the corresponding said rear side rail member; and
a pair of connecting members slidably received in guide rails mounted to said vehicle roof portion, each said connecting member pivotally connecting one of said track members to permit pivotal movement of said track members relative to said guide rails such that said track members are laterally movable along said guide rails and pivotally movable relative to said guide rails to position said storage surface generally vertically along said side portion of said automotive vehicle.

19. The roof rack apparatus of claim 18 wherein said roof rack apparatus further comprises front and rear transverse rail members pivotally movable between said raised basket-forming position and a lowered collapsed position to form a basket with said side rail members when in said raised basket-forming position.

20. The roof rack apparatus of claim 19 wherein said side rail members include a trim member selectively interengageable between adjacent front and rear side rail members, said trim member being movable to permit a gap to be formed between said adjacent front and rear side rail members when one of said side rail members is to be moved into said lowered collapsed position so that said side rail members can be lowered below said guide rails, said trim member being housed within one of said adjacent front and rear side rail members and is extendible therefrom to engage the other of said adjacent front and rear side rail members when said adjacent front and rear side rail members are in said raised position, said trim member being retractable into said one of said adjacent front and rear side rail members when any of said adjacent front and rear side rail members are to be placed into said lowered collapsed position.
